(19) United States
(12) Patent Application Publication
(10) Pub. No.: US 2026/0065690 A1
(43) Pub. Date: Mar. 5, 2026

(54) APPARATUS, METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Mitsuhiro MIURA, Toyota-shi (JP); Yoshiaki TOMATSU, Toyoake-shi (JP)

(73) Assignee: TOYOTA JIDOSHA KABUSHIKI KAISHA, Toyota-shi (JP)

(21) Appl. No.: 19/256,670

(22) Filed: Jul. 1, 2025

(30) Foreign Application Priority Data
Aug. 30, 2024 (JP) 2024-150078

(51) Int. Cl. G06V 20/58; E05F 15/73; G06T 7/20; G06V 20/59

(52) U.S. Cl. CPC G06V 20/58; E05F 15/73; G06T 7/20; G06V 20/59; E05F 2015/767; E05Y 2900/531

(57) ABSTRACT

A door control apparatus includes an imager and a controller. The controller acquires, from the imager, an image of the interior and exterior of the vehicle, detects an interior detection object and an exterior detection object from the image, determines whether the interior detection object is located within a vehicle interior detection zone, suspends an opening and closing operation of the door when the interior detection object is determined to be located within the vehicle interior detection zone, determines whether the exterior detection object is located within a vehicle exterior detection zone, and suspends a closing operation of the door when the exterior detection object is determined to be located within the vehicle exterior detection zone.

### CROSS-REFERENCE TO RELATED APPLICATION

This application claims priority to Japanese Patent Application No. 2024-150078 filed on Aug. 30, 2024, the entire contents of which are incorporated herein by reference.

### TECHNICAL FIELD

The present disclosure relates to an apparatus, a method, and a non-transitory computer readable medium.

### BACKGROUND

Technology for detecting people is known. For example, Patent Literature (PTL) 1 discloses technology for setting multiple detection areas on an image of a station platform.

### CITATION LIST

### Patent Literature

PTL 1: JP 2012-121483 A

### SUMMARY

Technology for detecting people can be used in systems that determine the suspension of opening and closing doors. People behave differently between when entering and when exiting a vehicle. Therefore, it is necessary to detect people outside the vehicle and people inside the vehicle separately. However, conventional systems detect only either the inside or outside of the vehicle.

It would be helpful to improve technology for detecting people in the vicinity of doors of vehicles.

A door control apparatus according to one embodiment of the present disclosure includes:
an imager configured to image the interior and exterior of a vehicle; and
a controller configured to:
   acquire, from the imager, an image of the interior and exterior of the vehicle;
   detect, from the image, an interior detection object that is a detection object inside the vehicle, and an exterior detection object that is a detection object outside the vehicle;
   suspend an opening and closing operation of a door when the interior detection object is located within a vehicle interior detection zone in the vicinity of the door inside the vehicle; and
   suspend a closing operation of the door when the exterior detection object is located within a vehicle exterior detection zone in the vicinity of the door outside the vehicle.

A method according to one embodiment of the present disclosure is a method performed by a door control apparatus including an imager configured to image the interior and exterior of a vehicle, and a controller, the method including:
acquiring, by the controller from the imager, an image of the interior and exterior of the vehicle;
detecting, by the controller from the image, an interior detection object that is a detection object inside the vehicle, and an exterior detection object that is a detection object outside the vehicle;
suspending, by the controller, an opening and closing operation of a door when the interior detection object is located within a vehicle interior detection zone in the vicinity of the door inside the vehicle; and
suspending, by the controller, a closing operation of the door when the exterior detection object is located within a vehicle exterior detection zone in the vicinity of the door outside the vehicle.

A non-transitory computer readable medium according to one embodiment of the present disclosure stores a program configured to cause a computer, as a door control apparatus including an imager configured to image the interior and exterior of a vehicle, and a controller, to execute operations including:
acquiring, from the imager, an image of the interior and exterior of the vehicle;
detecting, from the image, an interior detection object that is a detection object inside the vehicle, and an exterior detection object that is a detection object outside the vehicle;
suspending an opening and closing operation of a door when the interior detection object is located within a vehicle interior detection zone in the vicinity of the door inside the vehicle; and
suspending a closing operation of the door when the exterior detection object is located within a vehicle exterior detection zone in the vicinity of the door outside the vehicle.

According to an embodiment of the present disclosure, technology for detecting people is improved.

### BRIEF DESCRIPTION OF THE DRAWINGS

In the accompanying drawings:

FIG. 1 is a block diagram illustrating a schematic configuration of a door control apparatus according to an embodiment;

FIG. 2 is a flowchart illustrating operations of a door control apparatus according to a first embodiment;

FIG. 3 is a schematic diagram illustrating examples of a vehicle interior detection zone and a vehicle exterior detection zone according to the first embodiment;

FIG. 4 is a flowchart illustrating operations of a door control apparatus according to a second embodiment;

FIG. 5 is a schematic diagram illustrating an example of a vehicle exterior detection zone according to the second embodiment; and

FIG. 6 is a schematic diagram illustrating the vehicle exterior detection zone different from FIG. 5.

### DETAILED DESCRIPTION

Embodiments of the present disclosure will be described below, with reference to the drawings.

### Outline of Embodiment

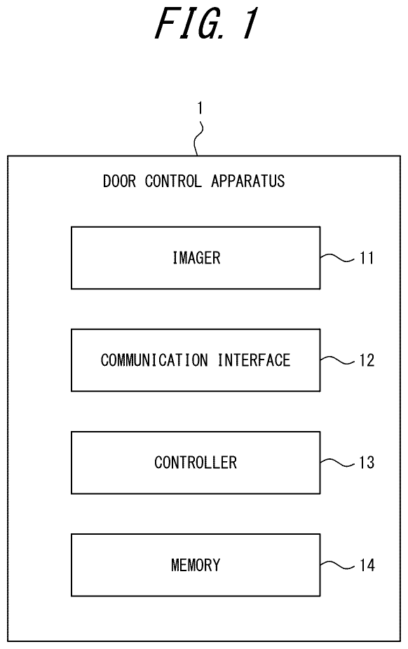

An outline of a door control apparatus 1 according to an embodiment of the present disclosure will be described with reference to FIG. 1. The door control apparatus 1 is a computer installed in a vehicle.

The vehicle includes any vehicle such as an automobile, a bus, and a shuttle bus. The vehicle may be a gasoline vehicle, a diesel vehicle, a hydrogen vehicle, a Battery Electric Vehicle (BEV), a Hybrid Electric Vehicle (HEV), a Plug-in Hybrid Electric Vehicle (PHEV), or a Fuel Cell Electric Vehicle (FCEV). The vehicle may be driven by a driver, or the driving may be automated at any level. The automation level is, for example, any one of Level 1 to Level 5 according to the level classification defined by the Society of Automotive Engineers (SAE). The vehicle may be a dedicated Mobility as a Service (MaaS) vehicle. The vehicle is provided with a controller that controls operations of various parts of the vehicle, including a door. In the present embodiment, the door is a sliding door. The door may be any other type of door, e.g., a hinged door.

First, an outline of the present embodiment will be described, and details thereof will be described later. The door control apparatus according to the present embodiment includes an imager that images an interior and exterior of the vehicle, and a controller. The controller acquires, from the imager, an image of the interior and exterior of the vehicle. The controller detects, from the image, an interior detection object, which is a detection object inside the vehicle, and an exterior detection object, which is a detection object outside the vehicle. The controller suspends an opening and closing operation of the door when the interior detection object is located within a vehicle interior detection zone in the vicinity of the door inside the vehicle. The controller suspends a closing operation of the door when the exterior detection object is located within a vehicle exterior detection zone in the vicinity of the door outside the vehicle.

According to the present embodiment, since detection zones have the vehicle interior detection zone and the vehicle exterior detection zone, it is possible to detect people inside and outside the vehicle separately. When the door opens and closes, people in the vicinity of the door who are inside the vehicle remain stationary, but people outside the vehicle may rush to get on. Therefore, the people outside the vehicle need to be detected earlier than the people inside the vehicle. According to the present embodiment, for example, setting the vehicle exterior detection zone larger, differently from the vehicle interior detection zone, makes it possible to detect the people outside the vehicle earlier. According to the present embodiment, automatically suspending the opening and closing operation of the door reduces a burden on a driver to operate the door, and prevents people from being caught in the door due to the driver's oversight.

According to the present embodiment, it is possible to detect people inside and outside the vehicle collectively, using only the single image. This reduces the number of cameras or other sensors that are necessary to detect people in the vicinity of the door, thereby reducing cost of door control. Therefore, the present embodiment improves technology for detecting people.

### Configuration of Door Control Apparatus 1

A configuration of the door control apparatus 1 is described with reference to FIG. 1. The door control apparatus 1 includes an imager 11, a communication interface 12, a controller 13, and a memory 14. These parts are communicably connected to each other via an in-vehicle network, such as a Controller Area Network (CAN), or a dedicated line.

The imager 11 is any imaging module that is installed in the vehicle and can image the interior and exterior of the vehicle. The imaging module includes at least one camera. The imager 11 is installed in such a location that can image the floor and road in the vicinity of the door, e.g., on the ceiling in the vicinity of the door. In one embodiment, the imager 11 collectively captures the interior and exterior of the vehicle in a single image. The image may be either a still image or a moving image.

The communication interface 12 includes at least one interface for communication for connecting to an in-vehicle network. The interface for communication is compatible with, for example, a controller area network (CAN) communication standard, a mobile communication standard such as the 4th generation (4G) or 5th generation (5G), a vehicle-to-everything (V2X) communication standard such as a dedicated short range communications (DSRC) or cellular V2X, or a wireless local area network (LAN) communication standard such as Institute of Electrical and Electronics Engineers 802.11 (IEEE802.11).

The controller 13 includes at least one processor, at least one programmable circuit, at least one dedicated circuit, or a combination thereof. The controller 13 controls operations of the door control apparatus 1. The controller 13 may include an electronic control unit (ECU). The controller 13 controls various parts of the door control apparatus 1.

The memory 14 includes at least one memory. Various memories included in the memory 14 may function as, for example, a main memory, an auxiliary memory, or a cache memory. The memory 14 stores information to be used for the operations of the door control apparatus 1 and information obtained by the results of the operations of the door control apparatus 1. The memory 14 may store a system program, an application program, embedded software, or the like. The information stored in the memory 14 may be updated with, for example, information acquired from a network via the communication interface 12.

The functions of the door control apparatus 1 are realized by executing a program, which is stored on a non-transitory computer readable medium according to one embodiment, using a processor as the controller 13. That is, the functions of the door control apparatus 1 are realized by software. The program causes a computer to execute the operations of the door control apparatus 1, thereby causing the computer to function as the door control apparatus 1. That is, the computer executes the operations of the door control apparatus 1 in accordance with the program to thereby function as the door control apparatus 1.

### Operation Flow of Door Control Apparatus 1 According to First Embodiment

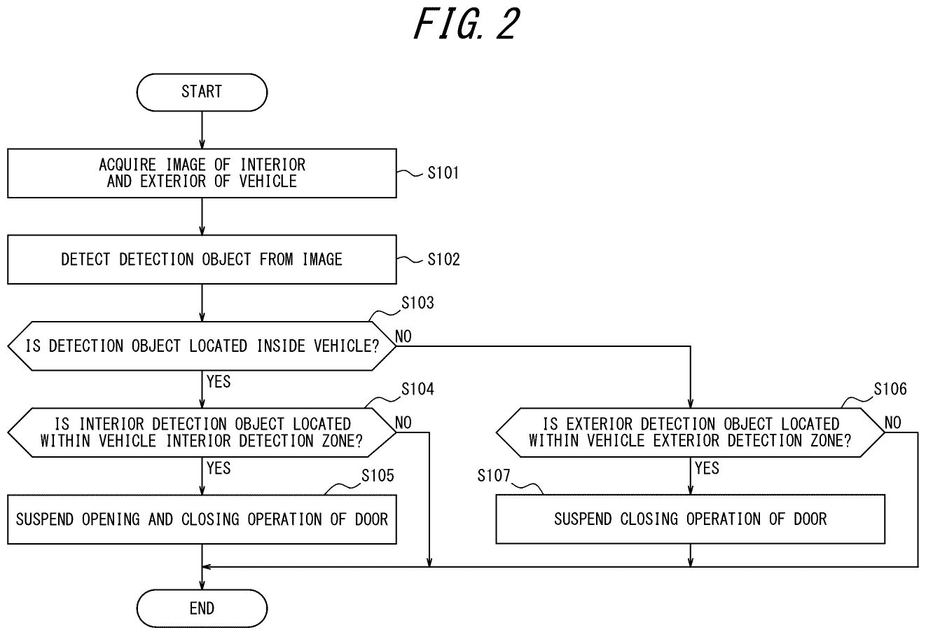

Operations of the door control apparatus 1 according to a first embodiment of the present disclosure will be described with reference to FIG. 2. In the following, communication between the various parts of the door control apparatus 1 is performed via the communication interface 12 and the network.

S101: The controller 13 acquires, from the imager 11, an image of the interior and exterior of the vehicle.

The imager 11 images the interior and exterior of the vehicle during the execution of an opening and closing operation of the door.

S102: The controller 13 detects a detection object from the image.

The detection object includes an interior detection object 2, which is a detection object inside the vehicle, and an exterior detection object 3, which is a detection object outside the vehicle. The detection object includes a person or baggage. The controller 13 detects the detection object from the image, using any object detection technology such as You Only Look Once (YOLO) and a convolutional neural network (CNN).

S103: The controller 13 determines whether the detection object is located inside the vehicle, i.e., whether the detection object is an interior detection object 2 or an exterior detection object 3. When it is determined that the detection object is located inside the vehicle (S103—YES), the process proceeds to S104. When it is determined that the detection object is located outside the vehicle (S103—NO), the process proceeds to S106.

For example, the controller 13 determines whether the detection object is located inside the vehicle, using the location of the detection object that is detected by the object detection technology in S102. For example, the controller 13 determines whether the detection object is located inside the vehicle by a feature value of the detection object in the acquired image.

S104: The controller 13 determines whether the interior detection object 2 is located within a vehicle interior detection zone 4. When it is determined that the interior detection object 2 is located within the vehicle interior detection zone 4 (S104—YES), the process proceeds to S105. When it is determined that the interior detection object 2 is not located within the vehicle interior detection zone 4 (S104—NO), the process ends.

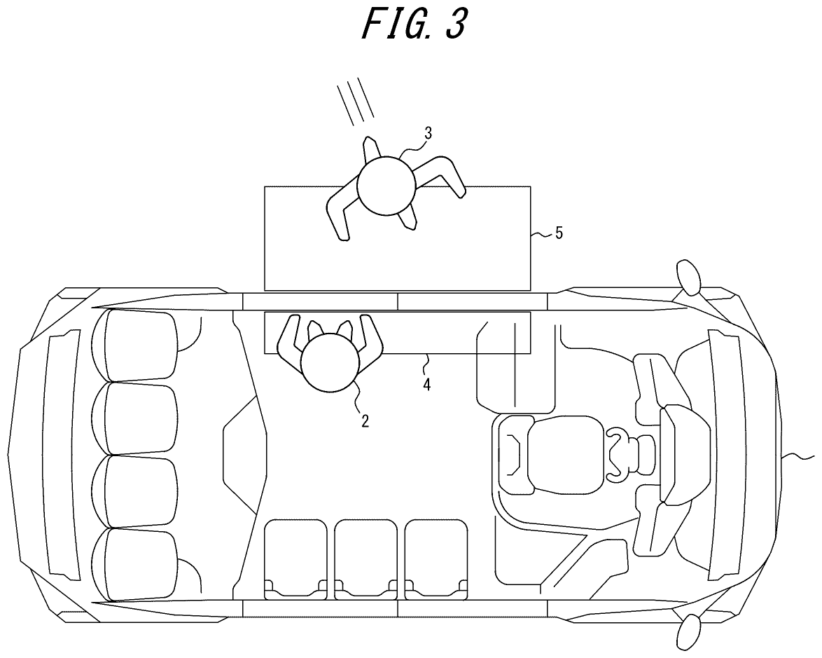

FIG. 3 is a schematic diagram illustrating examples of the vehicle interior detection zone 4 and the vehicle exterior detection zone 5. The vehicle interior detection zone 4 is located in the vicinity of the door inside the vehicle. The vehicle interior detection zone 4 is an area in any shape on the floor. In the first embodiment, the vehicle interior detection zone 4 is in the shape of a rectangle extending from the door to the inside of the vehicle, as illustrated in FIG. 3. In the first embodiment, the shape and area of the vehicle interior detection zone 4 do not vary. The controller 13 may determine that the interior detection object 2 is located within the vehicle interior detection zone 4 when part or all of the interior detection object 2 is located within the vehicle interior detection zone 4.

S105: The controller 13 suspends an opening and closing operation of the door.

When the door opens, a person inside the vehicle who is leaning against the door or who is exiting the door may fall through the door due to a step between the floor of the vehicle and the road. To prevent this fall, the controller 13 suspends an opening operation of the door. In addition, when the door closes, a person inside the vehicle may be injured with his/her hand or luggage being caught in the door. To prevent this injury, the controller 13 suspends a closing operation of the door.

S106: The controller 13 determines whether the exterior detection object 3 is located within a vehicle exterior detection zone 5. When it is determined that the exterior detection object 3 is located within the vehicle exterior detection zone 5 (S108—YES), the process proceeds to S109. When it is determined that the exterior detection object 3 is not located within the vehicle exterior detection zone 5 (S108—NO), the process ends.

For example, the controller 13 determines whether the exterior detection object 3 is located within the vehicle exterior detection zone by a feature value of the exterior detection object 3 in the acquired image. The vehicle exterior detection zone 5 is located in the vicinity of the door outside the vehicle. The vehicle exterior detection zone 5 is an area in any shape on the road or sidewalk. In the first embodiment, the vehicle exterior detection zone 5 is an area in the shape of a rectangle extending from the door to the outside of the vehicle, as illustrated in FIG. 3. In the first embodiment, as illustrated in FIG. 3, the shape and area of the vehicle exterior detection zone 5 do not vary. The controller 13 may determine that the exterior detection object 3 is located within the vehicle exterior detection zone 5 when part or all of the exterior detection object 3 is located within the vehicle exterior detection zone 5.

S107: The controller 13 suspends a closing operation of the door.

When the door closes, a person outside the vehicle may be injured with his/her hand or luggage being caught in the door. To prevent this injury, the controller 13 suspends a closing operation of the door. On the other hand, when the door opens, the person outside the vehicle does not fall through the door due to the step between the floor and the road. Therefore, in the first embodiment, the controller 13 does not suspend an opening operation of the door, as in S105. In S107, the controller 13 may suspend an opening operation of the door.

### Operation Flow of Door Control Apparatus 1 According to Second Embodiment

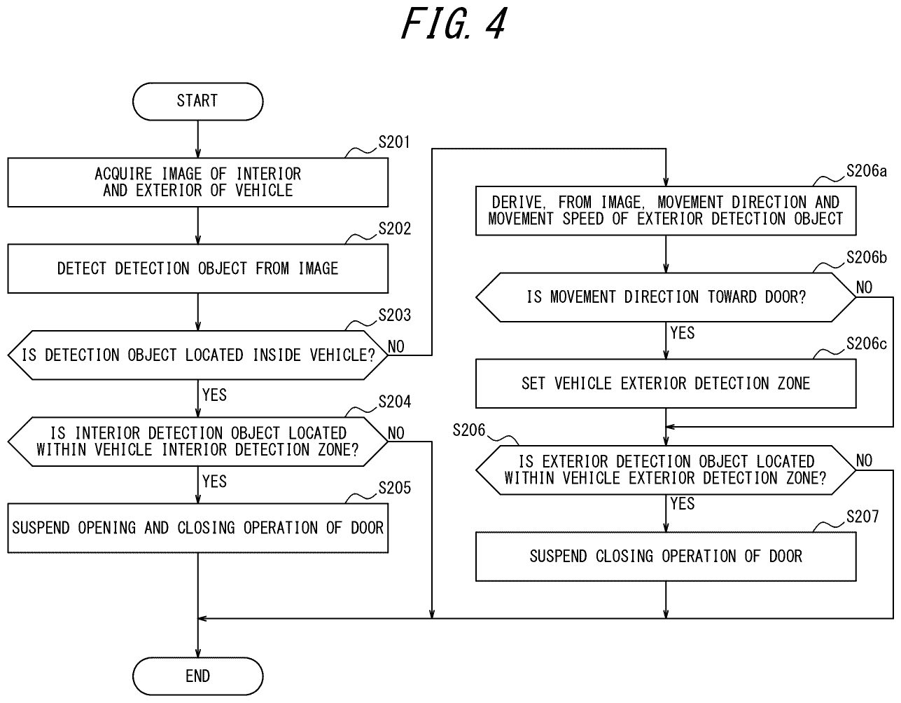

Operations of the door control apparatus 1 according to a second embodiment of the present disclosure will be described with reference to FIG. 4. S201 to S206 in the second embodiment are the same processes as S101 to S106 in the first embodiment, so explanations are omitted. In the second embodiment, the controller executes S206a to S206c before executing S206.

S206a: Before S206, the controller 13 derives, from the image, a movement direction and a movement speed of the exterior detection object 3.

The controller 13 derives, from the image, the movement direction and the movement speed of the exterior detection object 3, using any image analysis technology.

S206b: The controller 13 determines whether the movement direction of the exterior detection object 3 is a direction toward the door. When it is determined that the movement direction is the direction toward the door (S206b—YES), the process proceeds to S206c. When it is determined that the movement direction is not the direction toward the door (S206b—NO), the process proceeds to S206.

The “direction toward the door” means a direction in which the exterior detection object 3 approaches the door, for example, the center of the door. When it is determined that the movement direction is not the direction toward the door, there is no risk that a person outside the vehicle rushes to get on, so the process proceeds to S206. When it is determined that the movement direction is not the direction toward the door, the process may end.

S206c: The controller 13 sets the vehicle exterior detection zone 5 larger when the movement speed of the exterior detection object 3 is high than when the movement speed of the exterior detection object 3 is low. The process then proceeds to S206.

When a person is running, the closure of the door needs to be stopped earlier than when the person is walking. In the second embodiment, increasing the area of the vehicle exterior detection zone 5 according to the movement speed allows determination of the closure of the door earlier. In S206c, the controller may set the vehicle exterior detection zone 5 so that the higher the movement speed of the exterior detection object 3, the more the area of the vehicle exterior detection zone 5 increases.

To avoid detection of even a person who does not intend to get on the vehicle, the area of the vehicle exterior detection zone 5 may be set to be less than or equal to an area threshold. The controller 13 may set a closing speed of the door lower when the area of the vehicle exterior detection zone 5 is equal to the area threshold than when the area of the vehicle exterior detection zone 5 is less than the area threshold.

When the movement speed is less than a speed threshold, the controller 13 may maintain the area of the vehicle exterior detection zone 5 at a preset area. When the movement speed is greater than or equal to the speed threshold, the controller 13 may set the vehicle exterior detection zone 5 so that the higher the movement speed of the exterior detection object 3, the more the area of the vehicle exterior detection zone 5 increases.

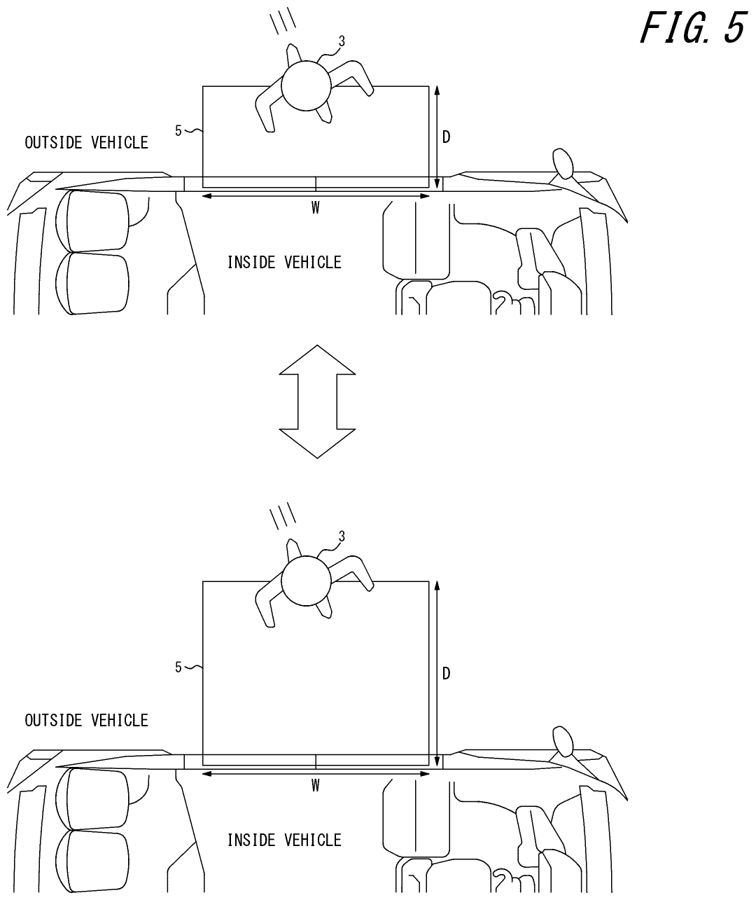

In the second embodiment, the vehicle exterior detection zone 5 is in the shape of a rectangle extending from the door to the outside of the vehicle. The vehicle exterior detection zone 5 has a length D extending in a vertical direction perpendicular to the door, and a width W extending perpendicular to the vertical direction. In the second embodiment, as illustrated in FIG. 5, the higher the movement speed, the more the length D increases. This allows earlier detection of the exterior detection object 3 with a high movement speed. Although not illustrated in FIG. 5, the higher the movement speed, the more the width W of the vehicle exterior detection zone 5 may increase. This also allows earlier detection of the exterior detection object 3 approaching along the sidewalk.

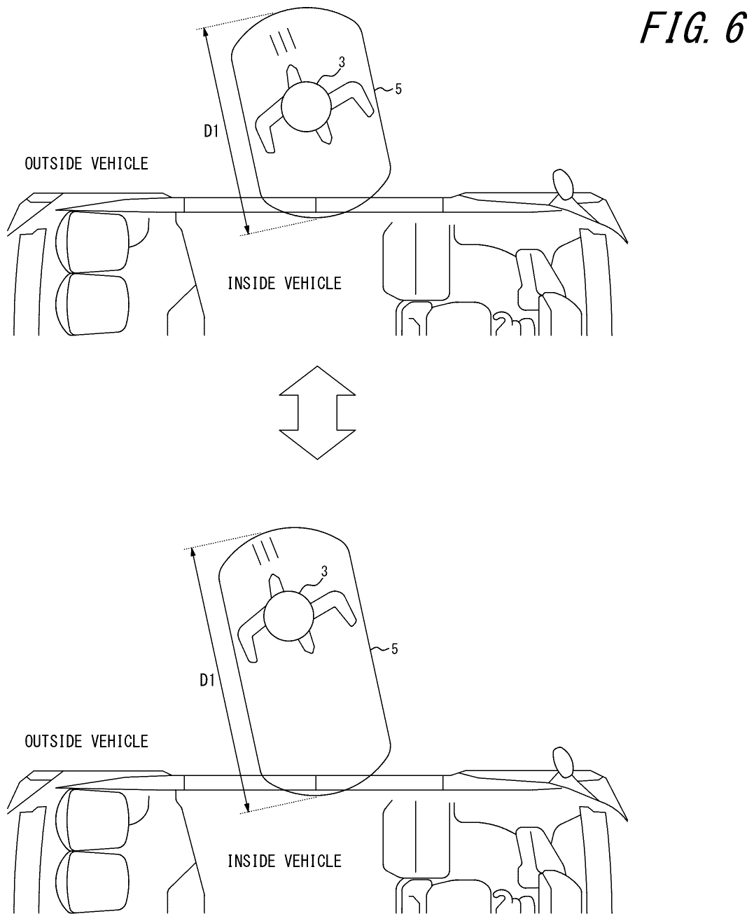

The vehicle exterior detection zone 5 may be in a shape extending in an extension direction that extends from the door, for example, the center of the door toward the exterior detection object 3. In FIG. 6, the vehicle exterior detection zone 5 is in the shape of a bar extending in the extension direction. In FIG. 6, the length D1 of the vehicle exterior detection zone 5 is larger along the extension direction when the movement speed is high than when the movement speed is low. The higher the movement speed, the more the length D1 of the vehicle exterior detection zone 5 along the extension direction may increase. The vehicle exterior detection zone 5 may include multiple zones as illustrated in FIG. 6. For example, the vehicle exterior detection zone 5 may include multiple individual zones. Each individual zone may extend in each extension direction that extends from the door toward each of multiple exterior detection objects 3. The length of each individual zone along each extension direction may be larger when the movement speed of each exterior detection object 3 is high than when the movement speed of each exterior detection object 3 is low. The higher the movement speed of each exterior detection object 3, the more the length of each individual zone along each extension direction may increase. The multiple individual zones allow the multiple exterior detection objects 3 to be detected individually according to the individual movement speeds.

As described above, the door control apparatus according to the present embodiment includes the imager that images an interior and exterior of the vehicle, and the controller. The controller acquires, from the imager, an image of the interior and exterior of the vehicle. The controller detects, from the image, an interior detection object, which is a detection object inside the vehicle, and an exterior detection object, which is a detection object outside the vehicle. The controller suspends an opening and closing operation of the door when the interior detection object is located within a vehicle interior detection zone in the vicinity of the door inside the vehicle. The controller suspends a closing operation of the door when the exterior detection object is located within a vehicle exterior detection zone in the vicinity of the door outside the vehicle.

According to the present embodiment, since detection zones have the vehicle interior detection zone and the vehicle exterior detection zone, it is possible to detect people inside and outside the vehicle separately. When the door opens and closes, people in the vicinity of the door who are inside the vehicle remain stationary, but people outside the vehicle may rush to get on. Therefore, the people outside the vehicle need to be detected earlier than the people inside the vehicle. According to the present embodiment, for example, setting the vehicle exterior detection zone larger, differently from the vehicle interior detection zone, makes it possible to detect the people outside the vehicle earlier. According to the present embodiment, automatically suspending the opening and closing operation of the door reduces a burden on the driver to operate the door, and prevents people from being caught in the door due to the driver's oversight.

According to the present embodiment, it is possible to detect people inside and outside the vehicle collectively, using only the single image. This reduces the number of cameras or other sensors that are necessary to detect people in the vicinity of the door, thereby reducing cost of door control. Therefore, the present embodiment improves technology for detecting people.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided. For example, an embodiment in which the configuration and operations of the door control apparatus in the above embodiment are distributed to multiple computers capable of communicating with each other can be implemented.

In another embodiment, in order to start the vehicle earlier, the controller 13 may reduce an opening and closing speed of the door in S105, S107, S205, or S207.

The door control apparatus may further include an output interface 15. The output interface 15 may be an audio speaker, or a display, or illumination embedded in the floor or the like in the vicinity of the door. The controller 13 may alert people inside or outside the vehicle by information output by the output interface 15. The output interface 15 can alert people in the vicinity of the door by outputting audio information on the audio speaker, or by displaying the vehicle interior detection zone 4 on the display or by the illumination.

After S206a, the controller 13 may determine whether the movement direction of the exterior detection object 3 is toward the door and whether the movement speed is greater than or equal to the speed threshold. When the movement direction of the exterior detection object 3 is toward the door and the movement speed is greater than or equal to the speed threshold, the area of the vehicle interior detection zone 4 may be increased, and the output interface 15 may alert the interior detection object 2 located within the vehicle interior detection zone 4.

When people outside the vehicle rush to get on the vehicle, the people outside the vehicle may collide with people inside the vehicle. Therefore, in order to prevent collisions, the area of the vehicle interior detection zone 4 may be increased, and the audio speaker may output audio information such as “Someone is rushing into the vehicle. Please move away from the door.” or the illumination may indicate the vehicle interior detection zone 4 on the display, to alert people within the vehicle interior detection zone 4.

For example, an embodiment in which a general purpose computer functions as the door control apparatus according to the above embodiment can also be implemented. Specifically, a program in which processes for realizing the functions of the door control apparatus according to the above embodiment are written may be stored in a memory of a general purpose computer, and the program is read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] A door control apparatus comprising:
an imager configured to image an interior and exterior of a vehicle; and
a controller configured to:
   acquire, from the imager, an image of the interior and exterior of the vehicle;
   detect, from the image using object detection technology, an interior detection object that is a detection object inside the vehicle, and an exterior detection object that is a detection object outside the vehicle;
   suspend an opening and closing operation of a door when the interior detection object is located within a vehicle interior detection zone in a vicinity of the door inside the vehicle; and
   suspend a closing operation of the door when the exterior detection object is located within a vehicle exterior detection zone in a vicinity of the door outside the vehicle.

[Appendix 2] The door control apparatus according to appendix 1, wherein the controller is further configured to:
derive a movement speed and a movement direction of the exterior detection object; and
when the movement direction is a direction toward the door, set the vehicle exterior detection zone larger when the movement speed is high than when the movement speed is low.

[Appendix 3] The door control apparatus according to appendix 2, wherein
the vehicle exterior detection zone extends in an extension direction from the door toward the exterior detection object, and
the vehicle exterior detection zone is larger in length along the extension direction when the movement speed is high than when the movement speed is low.

[Appendix 4] The door control apparatus according to appendix 2 or 3, wherein
an area of the vehicle exterior detection zone is set to be less than or equal to an area threshold, and
the controller is configured to make a closing speed of the door lower when the area of the vehicle exterior detection zone is equal to the area threshold than when the area of the vehicle exterior detection zone is less than the area threshold.

[Appendix 5] The door control apparatus according to any one of appendices 2 to 4, wherein
the vehicle exterior detection zone includes multiple individual zones,
each individual zone extends in each extension direction from the door toward each of multiple exterior detection objects, and
each individual zone is larger in length along each extension direction when the movement speed of each exterior detection object is high than when the movement speed of each exterior detection object is low.

[Appendix 6] The door control apparatus according to any one of appendices 2 to 5, further comprising an output interface,
wherein the controller is configured to, when the movement direction is a direction toward the door and the movement speed is greater than or equal to a speed threshold, increase an area of the vehicle interior detection zone, and alert an interior detection object located within the vehicle interior detection zone by the output interface.

[Appendix 7] The door control apparatus according to appendices 1 to 6, wherein the vehicle is an automated driving vehicle.

[Appendix 8] A method performed by a door control apparatus including an imager configured to image an interior and exterior of a vehicle, and a controller, the method comprising:
acquiring, by the controller from the imager, an image of the interior and exterior of the vehicle;
detecting, by the controller from the image using object detection technology, an interior detection object that is a detection object inside the vehicle, and an exterior detection object that is a detection object outside the vehicle;
suspending, by the controller, an opening and closing operation of a door when the interior detection object is located within a vehicle interior detection zone in a vicinity of the door inside the vehicle; and
suspending, by the controller, a closing operation of the door when the exterior detection object is located within a vehicle exterior detection zone in a vicinity of the door outside the vehicle.

[Appendix 9] The method according to appendix 8, further comprising:
deriving, by the controller, a movement speed and a movement direction of the exterior detection object; and
when the movement direction is a direction toward the door, setting, by the controller, the vehicle exterior detection zone larger when the movement speed is high than when the movement speed is low.

[Appendix 10] The method according to appendix 9, wherein
the vehicle exterior detection zone extends in an extension direction from the door toward the exterior detection object, and
the vehicle exterior detection zone is larger in length along the extension direction when the movement speed is high than when the movement speed is low.

[Appendix 11] The method according to appendix 9 or 10, wherein
an area of the vehicle exterior detection zone is set to be less than or equal to an area threshold, and
the controller is configured to make a closing speed of the door lower when the area of the vehicle exterior detection zone is equal to the area threshold than when the area of the vehicle exterior detection zone is less than the area threshold.

[Appendix 12] The method according to any one of appendices 9 to 11, wherein
the vehicle exterior detection zone includes multiple individual zones,
each individual zone extends in each extension direction from the door toward each of multiple exterior detection objects, and
each individual zone is larger in length along each extension direction when the movement speed of each exterior detection object is high than when the movement speed of each exterior detection object is low.

[Appendix 13] The method according to any one of appendices 9 to 12, further comprising, when the movement direction is a direction toward the door and the movement speed is greater than or equal to a speed threshold, increasing, by the controller, an area of the vehicle interior detection zone, and alerting, by the controller, an interior detection object located within the vehicle interior detection zone.

[Appendix 14] The method according to appendices 8 to 13, wherein the vehicle is an automated driving vehicle.

[Appendix 15] A non-transitory computer readable medium storing a program configured to cause a computer, as a door control apparatus including an imager configured to image an interior and exterior of a vehicle, and a controller, to execute operations, the operations comprising:
acquiring, from the imager, an image of the interior and exterior of the vehicle;
detecting, from the image using object detection technology, an interior detection object that is a detection object inside the vehicle, and an exterior detection object that is a detection object outside the vehicle;
suspending an opening and closing operation of a door when the interior detection object is located within a vehicle interior detection zone in a vicinity of the door inside the vehicle; and
suspending a closing operation of the door when the exterior detection object is located within a vehicle exterior detection zone in a vicinity of the door outside the vehicle.

[Appendix 16] The medium according to appendix 15, wherein the operations further comprise:
deriving a movement speed and a movement direction of the exterior detection object; and
when the movement direction is a direction toward the door, setting the vehicle exterior detection zone larger when the movement speed is high than when the movement speed is low.

[Appendix 17] The medium according to appendix 16, wherein
the vehicle exterior detection zone extends in an extension direction from the door toward the exterior detection object, and
the vehicle exterior detection zone is larger in length along the extension direction when the movement speed is high than when the movement speed is low.

[Appendix 18] The medium according to appendix 16 or 17, wherein
an area of the vehicle exterior detection zone is set to be less than or equal to an area threshold, and
the controller is configured to make a closing speed of the door lower when the area of the vehicle exterior detection zone is equal to the area threshold than when the area of the vehicle exterior detection zone is less than the area threshold.

[Appendix 19] The medium according to any one of appendices 16 to 17, wherein
the vehicle exterior detection zone includes multiple individual zones,
each individual zone extends in each extension direction from the door toward each of multiple exterior detection objects, and
each individual zone is larger in length along each extension direction when the movement speed of each exterior detection object is high than when the movement speed of each exterior detection object is low.

[Appendix 20] The medium according to appendices 15 to 19, wherein the vehicle is an automated driving vehicle.

1. A door control apparatus comprising:
an imager configured to image an interior and exterior of a vehicle; and
a controller configured to:
acquire, from the imager, an image of the interior and exterior of the vehicle;
detect, from the image using object detection technology, an interior detection object that is a detection object inside the vehicle, and an exterior detection object that is a detection object outside the vehicle;
suspend an opening and closing operation of a door when the interior detection object is located within a vehicle interior detection zone in a vicinity of the door inside the vehicle; and
suspend a closing operation of the door when the exterior detection object is located within a vehicle exterior detection zone in a vicinity of the door outside the vehicle.

2. The door control apparatus according to claim 1, wherein the controller is further configured to:
derive a movement speed and a movement direction of the exterior detection object; and
when the movement direction is a direction toward the door, set the vehicle exterior detection zone larger when the movement speed is high than when the movement speed is low.

3. The door control apparatus according to claim 2, wherein
the vehicle exterior detection zone extends in an extension direction from the door toward the exterior detection object, and
the vehicle exterior detection zone is larger in length along the extension direction when the movement speed is high than when the movement speed is low.

4. The door control apparatus according to claim 2, wherein
an area of the vehicle exterior detection zone is set to be less than or equal to an area threshold, and
the controller is configured to make a closing speed of the door lower when the area of the vehicle exterior detection zone is equal to the area threshold than when the area of the vehicle exterior detection zone is less than the area threshold.

5. The door control apparatus according to claim 2, wherein
the vehicle exterior detection zone includes multiple individual zones,
each individual zone extends in each extension direction from the door toward each of multiple exterior detection objects, and
each individual zone is larger in length along each extension direction when the movement speed of each exterior detection object is high than when the movement speed of each exterior detection object is low.

6. The door control apparatus according to claim 2, further comprising an output interface,
wherein the controller is configured to, when the movement direction is a direction toward the door and the movement speed is greater than or equal to a speed threshold, increase an area of the vehicle interior detection zone, and alert an interior detection object located within the vehicle interior detection zone by the output interface.

7. The door control apparatus according to claim 1, wherein the vehicle is an automated driving vehicle.

8. A method performed by a door control apparatus including an imager configured to image an interior and exterior of a vehicle, and a controller, the method comprising:
acquiring, by the controller from the imager, an image of the interior and exterior of the vehicle;
detecting, by the controller from the image using object detection technology, an interior detection object that is a detection object inside the vehicle, and an exterior detection object that is a detection object outside the vehicle;
suspending, by the controller, an opening and closing operation of a door when the interior detection object is located within a vehicle interior detection zone in a vicinity of the door inside the vehicle; and
suspending, by the controller, a closing operation of the door when the exterior detection object is located within a vehicle exterior detection zone in a vicinity of the door outside the vehicle.

9. The method according to claim 8, further comprising:
deriving, by the controller, a movement speed and a movement direction of the exterior detection object; and
when the movement direction is a direction toward the door, setting, by the controller, the vehicle exterior detection zone larger when the movement speed is high than when the movement speed is low.

10. The method according to claim 9, wherein
the vehicle exterior detection zone extends in an extension direction from the door toward the exterior detection object, and
the vehicle exterior detection zone is larger in length along the extension direction when the movement speed is high than when the movement speed is low.

11. The method according to claim 9, wherein
an area of the vehicle exterior detection zone is set to be less than or equal to an area threshold, and
the controller is configured to make a closing speed of the door lower when the area of the vehicle exterior detection zone is equal to the area threshold than when the area of the vehicle exterior detection zone is less than the area threshold.

12. The method according to claim 9, wherein
the vehicle exterior detection zone includes multiple individual zones,
each individual zone extends in each extension direction from the door toward each of multiple exterior detection objects, and
each individual zone is larger in length along each extension direction when the movement speed of each exterior detection object is high than when the movement speed of each exterior detection object is low.

13. The method according to claim 9, further comprising, when the movement direction is a direction toward the door and the movement speed is greater than or equal to a speed threshold, increasing, by the controller, an area of the vehicle interior detection zone, and alerting, by the controller, an interior detection object located within the vehicle interior detection zone.

14. The method according to claim 8, wherein the vehicle is an automated driving vehicle.

15. A non-transitory computer readable medium storing a program configured to cause a computer, as a door control apparatus including an imager configured to image an interior and exterior of a vehicle, and a controller, to execute operations, the operations comprising:
acquiring, from the imager, an image of the interior and exterior of the vehicle;
detecting, from the image using object detection technology, an interior detection object that is a detection object inside the vehicle, and an exterior detection object that is a detection object outside the vehicle;
suspending an opening and closing operation of a door when the interior detection object is located within a vehicle interior detection zone in a vicinity of the door inside the vehicle; and
suspending a closing operation of the door when the exterior detection object is located within a vehicle exterior detection zone in a vicinity of the door outside the vehicle.

16. The medium according to claim 15, wherein the operations further comprise:
deriving a movement speed and a movement direction of the exterior detection object; and
when the movement direction is a direction toward the door, setting the vehicle exterior detection zone larger when the movement speed is high than when the movement speed is low.

17. The medium according to claim 16, wherein
the vehicle exterior detection zone extends in an extension direction from the door toward the exterior detection object, and
the vehicle exterior detection zone is larger in length along the extension direction when the movement speed is high than when the movement speed is low.

18. The medium according to claim 16, wherein
an area of the vehicle exterior detection zone is set to be less than or equal to an area threshold, and
the controller is configured to make a closing speed of the door lower when the area of the vehicle exterior detection zone is equal to the area threshold than when the area of the vehicle exterior detection zone is less than the area threshold.

19. The medium according to claim 16, wherein
the vehicle exterior detection zone includes multiple individual zones,
each individual zone extends in each extension direction from the door toward each of multiple exterior detection objects, and
each individual zone is larger in length along each extension direction when the movement speed of each exterior detection object is high than when the movement speed of each exterior detection object is low.

20. The medium according to claim 15, wherein the vehicle is an automated driving vehicle.
